(19) United States
(12) Patent Application Publication
(10) Pub. No.: US 2014/0311770 A1
(43) Pub. Date: Oct. 23, 2014

(54) CABLE ORGANIZATION UNIT

(71) Applicant: Kevin Fong Chen, Anaheim, CA (US)

(72) Inventor: Kevin Fong Chen, Anaheim, CA (US)

(21) Appl. No.: 13/865,209

(22) Filed: Apr. 18, 2013

(51) Int. Cl. H02G 3/00

(52) U.S. Cl. CPC H02G 3/26
USPC 174/135

(57) ABSTRACT

A cable organization unit includes a foam structure body. The foam structure body has a base section. The base section has a first face. A first extension end perpendicularly protrudes from a middle section of the first face of the base section. A second extension end and a third extension end respectively extend from two sides of the base section to the first extension end. Each of the first, second and third extension ends has a free end. The free ends of the first, second and third extension ends are adjacent to each other, whereby the first, second and third extension ends define a first receiving space and a second receiving space. By means of the cable organization unit, a user can much more conveniently organize cables.

### BACKGROUND OF THE INVENTION

1. Field of the Invention

The present invention relates generally to a cable organization unit, and more particularly to a cable organization unit, which is flexible and can be more conveniently arranged.

2. Description of the Related Art

In daily life, various electronic products and domestic electrical appliances are generally provided with power cables connected to external power supply. It is always a bothering thing to arrange or store the cables. In the case that the cables are scattered on the ground without being well fixed on a wall, the cables will become visual nuisance to ruin the appearance. Also, the space for arrangement of the cables is often limited.

Conventionally, the cables are often directly randomly rolled up or tied up with a rubber ring or an iron wire for organization and storage. The cables are likely to damage in these processes. Also, this will lead to poor appearance. FIG. 1 shows a conventional cable organization structure, which is a protection jacket 4. The protection jacket 4 has a backboard 41 to define a cable receiving space 42. The cable 5 can be received in the cable receiving space 42. In the case of a very long cable 5, it is laborious and time-consuming to place the cable 5 into the projection jacket 4. Moreover, when taking out the cable 5, it is necessary to detach the backboard 41 from the protection jacket 4. This is quite inconvenient. FIG. 2 shows another conventional cable organization structure, which is a receiving sleeve 6. The cable 5 is first organized to a certain size and then placed into the receiving sleeve 6. Such cable organization structure can hardly provide cable organization function so that the cable is often tangled. FIG. 3 shows still another conventional cable organization structure, which is an automatic cable winder 7. The automatic cable winder 7 has a housing 71, a cable winder and an elastic member (not shown). The cable winder is disposed in the housing 71 for winding the cable. The cable 5 can be pulled out of the housing 71 and unwound from the cable winder to rotate the cable winder. The elastic member serves to elastically restore the cable winder so as to automatically wind the cable 5. The automatic cable winder can be conveniently used. However, after a lone period of use, the elastic member is subject to elastic fatigue. Under such circumstance, it will be impossible for the cable winder to successfully wind up the cable 5. Therefore, the lifetime of the automatic cable winder 7 is short. Moreover, the components of the automatic cable winder 7 are complicated. In case of malfunction, it is hard to repair the automatic cable winder 7.

### SUMMARY OF THE INVENTION

It is therefore a primary object of the present invention to provide a cable organization unit, which is flexible and can be more conveniently installed.

To achieve the above and other objects, the cable organization unit includes a foam structure body. The foam structure body has a base section. The base section has a first face. A first extension end perpendicularly protrudes from a middle section of the first face of the base section. A second extension end and a third extension end respectively extend from two sides of the base section to the first extension end. Each of the first, second and third extension ends has a free end. The free ends of the first, second and third extension ends are adjacent to each other, whereby the first, second and third extension ends define a first receiving space and a second receiving space.

The cable organization unit is flexible and can be snugly attached to an irregular place or a turn. Accordingly, the cable organization unit can be flexibly arranged. Moreover, the flexible second and third extension ends of the cable organization unit can be manually repeatedly biased to place the cables into the cable organization unit or take out the cables from the cable organization unit without using any tool. Alternatively, the cables can be partially exposed to outer side.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein:

FIG. 1 is a perspective view of a conventional cable organization structure;

FIG. 2 is a perspective view of another conventional cable organization structure;

FIG. 3 is a perspective view of still another conventional cable organization structure;

FIG. 4 is a perspective view of a first embodiment of the cable organization unit of the present invention;

FIG. 5 is a sectional view of a second embodiment of the cable organization unit of the present invention;

FIG. 6 is a sectional view of a third embodiment of the cable organization unit of the present invention;

FIG. 7 is a sectional view of a fourth embodiment of the cable organization unit of the present invention;

FIG. 8 is a sectional view of a fifth embodiment of the cable organization unit of the present invention;

FIG. 9 is a perspective view showing the operation of the cable organization unit of the present invention;

FIG. 10 is a perspective view showing the installation of the cable organization unit of the present invention;

FIG. 11 is a perspective view showing the installation of the cable organization unit of the present invention; and

FIG. 12 is a perspective view showing the storage of the cable organization unit of the present invention.

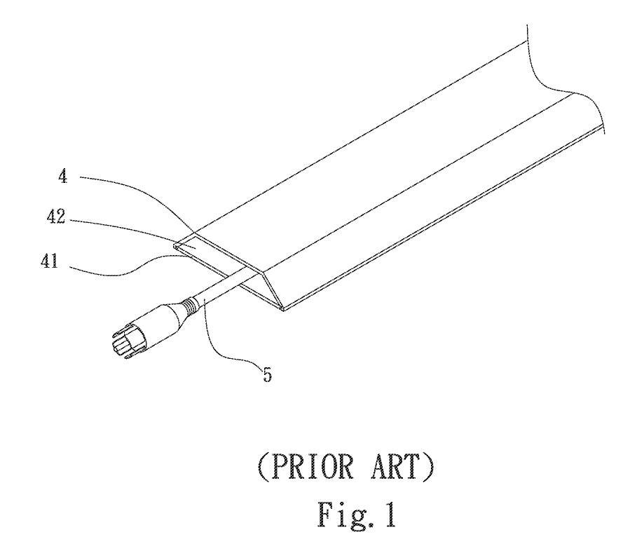

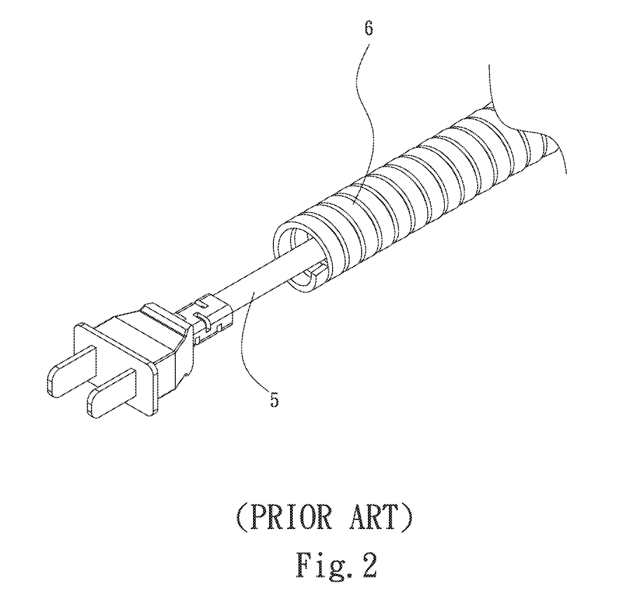

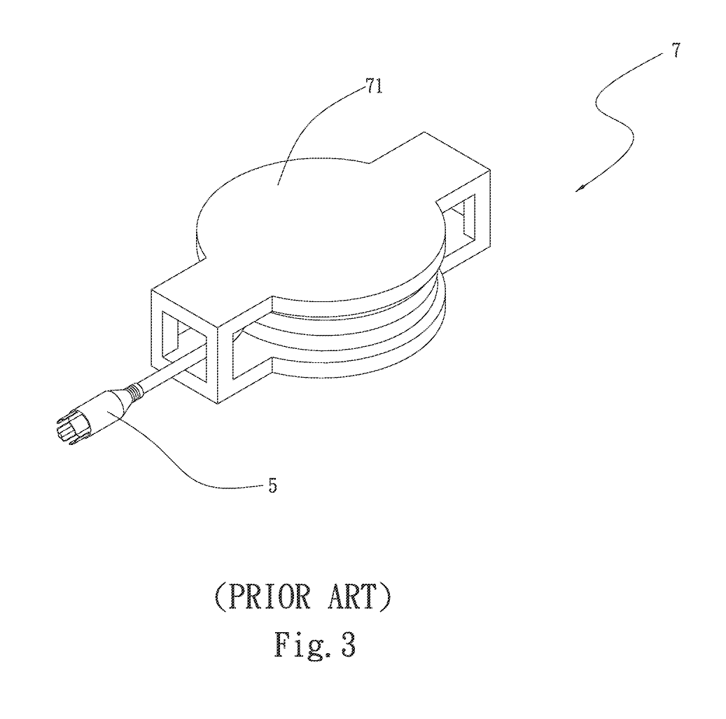

### DETAILED DESCRIPTION OF THE PREFERRED EMBODIMENTS

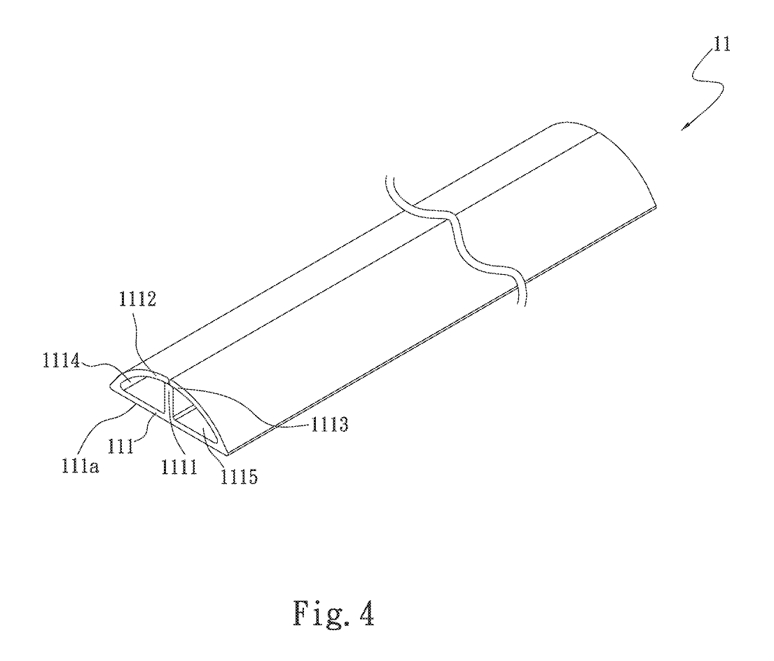

Please refer to FIG. 4, which is a perspective view of a first embodiment of the cable organization unit of the present invention. According to the first embodiment, the cable organization unit of the present invention includes a foam structure body 11.

The foam structure body 11 has a base section 111. The base section 111 has a first face 111a. A first extension end 1111 perpendicularly protruding from a middle section of the first face 111a of the base section 111 in a direction away from the first face 111a. A second extension end 1112 and a third extension end 1113 respectively extend from two sides of the base section 111 to the first extension end 1111. Each of the first, second and third extension ends 1111, 1112, 1113 has a free end. The free ends of the first, second and third extension ends 1111, 1112, 1113 are adjacent to each other, whereby the first, second and third extension ends 1111, 1112, 1113 define a first receiving space 1114 and a second receiving space 1115.

The second and third extension ends 1112, 1113 extend in an arched form. The first receiving space 1114 is defined by the first and second extension ends 1111, 1112, while the second receiving space 1115 is defined by the first and third extension ends 1111, 1113. The free ends of the first, second and third extension ends 1111, 1112, 1113 are in contact with each other.

The material of the foam structure body 11 is selected from a group consisting of rubber, sponge, polyurethane (PU), polypropylene (PP), polyethylene (PE), ethylene vinyl acetate (EVA), polystyrene (PS) and nylon. The foam structure body 11 is flexible.

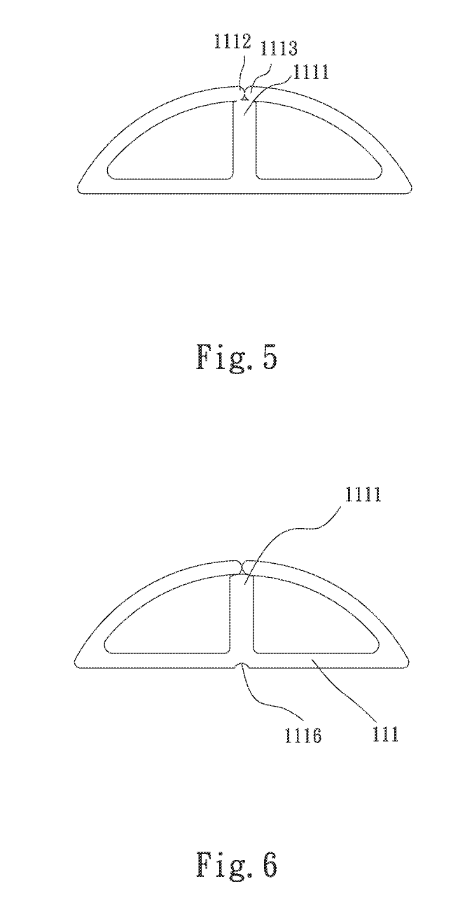

Please now refer to FIG. 5, which is a sectional view of a second embodiment of the cable organization unit of the present invention. The second embodiment is partially identical to the first embodiment in structure and connection relationship and thus will not be repeatedly described hereinafter. The second embodiment is different from the first embodiment in that the free ends of the first, second and third extension ends 1111, 1112, 1113 are adhered to each other by means of plastic extrusion molding or high temperature fusion.

Please now refer to FIG. 6, which is a sectional view of a third embodiment of the cable organization unit of the present invention. The third embodiment is partially identical to the first embodiment in structure and connection relationship and thus will not be repeatedly described hereinafter. The third embodiment is different from the first embodiment in that a recess 1116 is formed on one face of the base section 111, which face is opposite to the first face 111a of the base section 111.

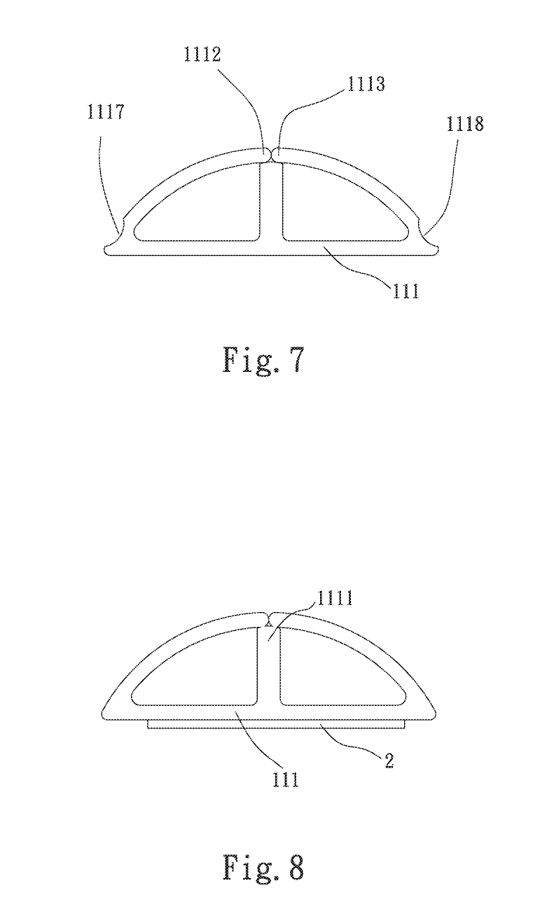

Please now refer to FIG. 7, which is a sectional view of a fourth embodiment of the cable organization unit of the present invention. The fourth embodiment is partially identical to the first embodiment in structure and connection relationship and thus will not be repeatedly described hereinafter. The fourth embodiment is different from the first embodiment in that a first recess 1117 is formed on a junction between the second extension end 1112 and the base section 111 and a second recess 1118 is formed on a junction between the third extension end 1113 and the base section 111. The first and second recesses 1117, 1118 enable a user to bias the second and third extension ends 1112, 1113 by larger operation angle.

Please now refer to FIG. 8, which is a sectional view of a fifth embodiment of the cable organization unit of the present invention. The fifth embodiment is partially identical to the first embodiment in structure and connection relationship and thus will not be repeatedly described hereinafter. The fifth embodiment is different from the first embodiment in that a self-adhesive material 2 is disposed on one face of the base section 111, which face is opposite to the first face 111a of the base section 111.

By means of the self-adhesive material 2, a user can more conveniently affix the cable organization unit of the present invention to a desired position.

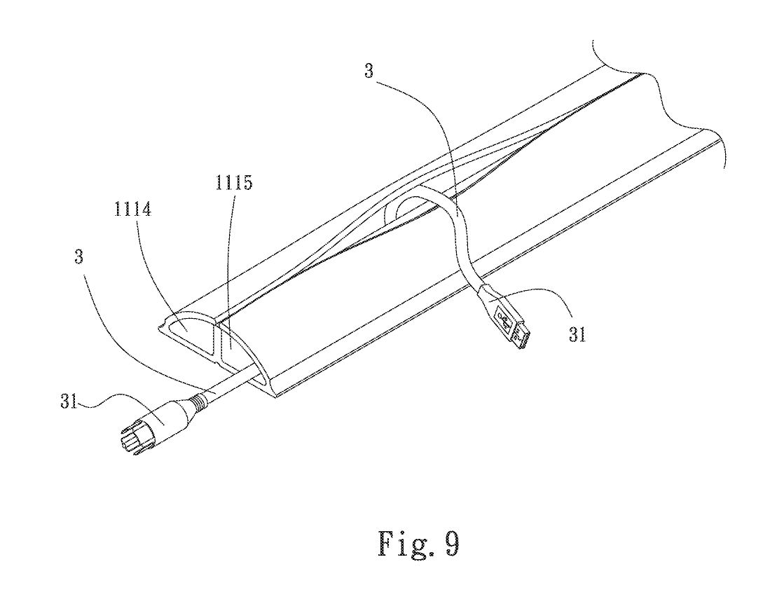

Please now refer to FIGS. 9, 10, 11 and 12, which show the operation of the cable organization unit of the present invention. The cable organization unit of the present invention is flexible so that it is convenient to operate or store the cable organization unit of the present invention. A user can affix the cable organization unit in a desired wiring path by means of the self-adhesive material 2 (with reference to FIG. 8) or any other suitable measure. Then the cables 3 can be disposed in the first and second receiving spaces 1114, 1115 (as shown in FIG. 9). Parts of the cables 3 can be conveniently pulled out of the first and second receiving spaces 1114, 1115 to expose the plugs 31 of the cables 3 to outer side.

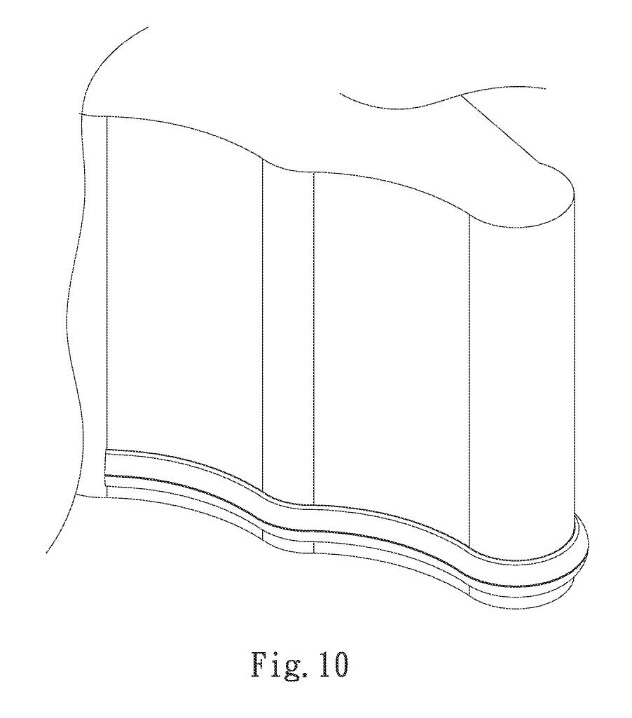

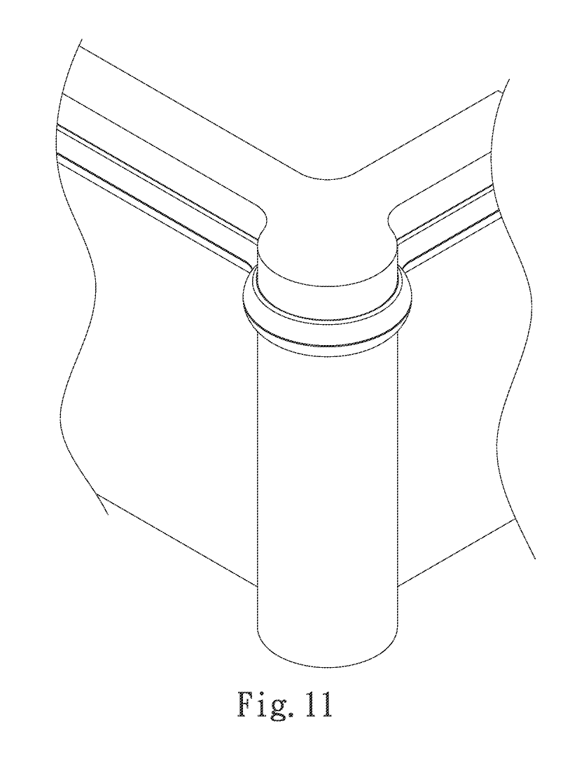

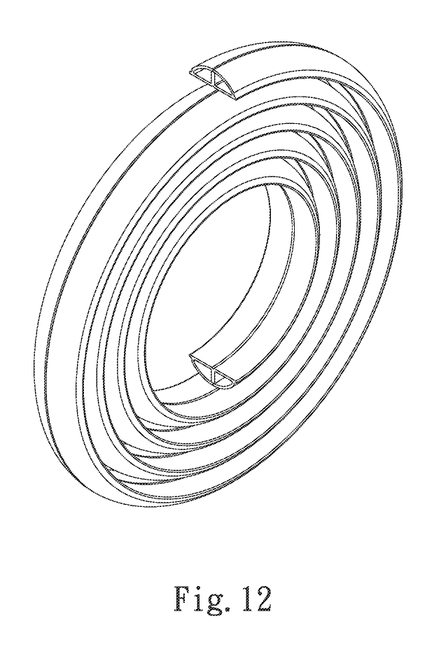

The cable organization unit is flexible so that it can be freely bent and arranged on a place with continuous arched turns (as shown in FIG. 10) or a wall corner with a round angle (as shown in FIG. 11). When not used, the cable organization unit can be rolled up and stored (as shown in FIG. 12). This is quite convenient.

Moreover, the cable organization unit of the present invention is a foam structure body so that it can be easily cut off with a pair of scissors for convenient use.

The present invention has been described with the above embodiments thereof and it is understood that many changes and modifications in the above embodiments can be carried out without departing from the scope and the spirit of the invention that is intended to be limited only by the appended claims.

What is claimed is:

1. A cable organization unit comprising a foam structure body, the foam structure body having a base section, the base section having a first face, a first extension end perpendicularly protruding from a middle section of the first face of the base section, a second extension end and a third extension end respectively extending from two sides of the base section to the first extension end, each of the first, second and third extension ends having a free end, the free ends of the first, second and third extension ends being adjacent to each other, whereby the first, second and third extension ends define a first receiving space and a second receiving space.

2. The cable organization unit as claimed in claim 1, wherein the free ends of the first, second and third extension ends are in contact with each other.

3. The cable organization unit as claimed in claim 1, wherein the free ends of the first, second and third extension ends are adhered to each other.

4. The cable organization unit as claimed in claim 3, wherein the free ends of the first, second and third extension ends are adhered to each other by means of plastic extrusion molding or high temperature fusion.

5. The cable organization unit as claimed in claim 1, wherein the first receiving space is defined by the first and second extension ends.

6. The cable organization unit as claimed in claim 1, wherein the second receiving space is defined by the first and third extension ends.

7. The cable organization unit as claimed in claim 1, wherein the second and third extension ends extend in an arched form.

8. The cable organization unit as claimed in claim 1, wherein the first extension end perpendicularly protrudes from the middle section of the first face of the base section in a direction away from the first face.

9. The cable organization unit as claimed in claim 1, wherein a recess is formed on one face of the base section, which face is opposite to the first face of the base section.

10. The cable organization unit as claimed in claim 1, wherein a first recess is formed on a junction between the second extension end and the base section and a second recess is formed on a junction between the third extension end and the base section.

11. The cable organization unit as claimed in claim 1, wherein a self-adhesive material is disposed on one face of the base section, which face is opposite to the first face of the base section.

12. The cable organization unit as claimed in claim 1, wherein the material of the foam structure body is selected from a group consisting of rubber, sponge, polyurethane (PU), polypropylene (PP), polyethylene (PE), ethylene vinyl acetate (EVA), polystyrene (PS) and nylon.

13. The cable organization unit as claimed in claim 1, wherein the foam structure body is flexible.
